(19) United States
(12) Patent Application Publication
(10) Pub. No.: US 2004/0115449 A1
(43) Pub. Date: Jun. 17, 2004

(54) Display panel

(75) Inventors: Jeffrey Cooke, Harrow (GB); Philip Smith, Webster, NY (US)

Correspondence Address: Pamela R. Crocker, Patent Legal Staff, Estman Kodak Company, 343 State Street, Rochester, NY, 14650-2201, US

(73) Assignee: Eastman Kodak Company

(21) Appl. No.: 10/720,588

(22) Filed: Nov. 24, 2003

(30) Foreign Application Priority Data
Dec. 13, 2002 (GB) 0229090.6

(51) Int. Cl. B05D 1/36

(52) U.S. Cl. 428/472.2; 428/650; 427/402

(57) ABSTRACT

A display panel is formed by coating an opaque support layer with at least one layer carrying an image. The opaque support layer provides the necessary stiffness to the panel.

### CROSS REFERENCE TO RELATED APPLICATIONS

This is a U.S. patent application which claims priority of Great Britain patent application No. 0229090.6 filed Dec. 13, 2002.

### FIELD OF THE INVENTION

This invention relates to the field of display panels used in exhibitions and the like where short term advertising is required.

### BACKGROUND OF THE INVENTION

Easily erected and dismantled short term displays are often required for use in exhibitions, stores and such like. These are typically constructed as an aluminum framework which folds easily and springs up, much like an umbrella, when erected. The framework is then clad with flexible panels of either photographic or ink-jet media. These panels are attached to the framework using magnetic strips or similar attachment means. The display panels are typically 81.3 cm (32 inches) wide. However they may be joined to form large displays. Curved panels may be used for the ends of the display. Clip on lighting may also be supplied.

The display panels are typically formed as a laminated sandwich. The back of the media bearing the image is laminated with a material which is totally light opaque to prevent light from the back of the display degrading the image quality. An example of such a material is a polyester/aluminum sandwich. This laminate also adds stiffness to the finished product. The top laminate, typically a polyester acrylic, provides a robust, scratch resistant, non reflective surface. It also adds to the rigidity of the finished product.

### PROBLEM TO BE SOLVED BY THE INVENTION

Laminating the media carrying the image is a time consuming additional step in producing a display panel. It is also a costly addition.

It is known for paper media to split through the paper fibers when the panels are handled. This leads to unsightly damage of the panel edges which also reduces the life of the product. Piping or tunnelling can also occur. This is when the laminate adhesive separates from the media. This may occur if the panels are rolled too tightly. Pressure sensitive adhesives are particularly prone to this.

### SUMMARY OF THE INVENTION

It is an aim of the invention to provide a display panel which is not subject to the above mentioned problems.

According to the present invention there is provided a method of forming a display panel comprising the step of coating an opaque support layer with at least one image carrying layer, the support layer providing stiffness to the panel.

The image carrying layer may be an emulsion layer or an inkjet receiving layer. Preferably the opaque support layer is pre-coated with a gel coat. This can be textured to provide a non glossy characteristic to the surface of the panel. Preferably the image carrying layer is also coated with a waterproof overcoat which is permeable but which becomes waterproof during drying. This gives the display panel a more robust surface.

The invention further provides a display panel comprising an opaque support layer coated with at least one image carrying layer, the support layer providing stiffness to the panel.

### ADVANTAGEOUS EFFECT OF THE INVENTION

A display panel according to the present invention does not need to be laminated. As the lamination step is not required the time taken to produce the panel is reduced. Furthermore, there is no risk of the panel splitting or any risk of piping and tunnelling.

The display panel is also cheaper to manufacture than those known in the prior art since the cost of lamination is eliminated.

### BRIEF DESCRIPTION OF THE DRAWINGS

The invention will now be described, by way of example, with reference to the accompanying drawing, in which:

FIG. 1 is a schematic cross-sectional view of a display panel in accordance with an embodiment of the invention.

### DETAILED DESCRIPTION OF THE INVENTION

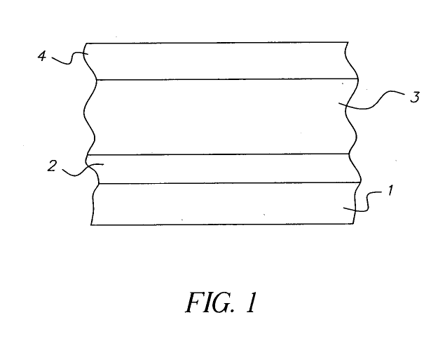

FIG. 1 illustrates a panel according to the invention.

The display panel illustrated in FIG. 1 has four layers. However this is a preferred embodiment and, as described later, not all layers are essential to the invention.

The back layer 1 of the panel is made from an opaque material. A preferred option is a plastics material such as an opaque polymer or polyester. This totally light opaque layer can be directly coated with a photographic emulsion, gel coat or ink receiver layer.

It will be understood that the invention is not limited to a back layer formed of plastics. Other possible materials for the back layer 1 could be aluminum, Estar™, an Estar/tungsten sandwich or a resin coated paper. These examples are not to be taken as limiting the invention.

The back layer could also be textured either due to roughening agents applied in the plastics or by embossing the surface, as in resin coating. When coated with the image receiving layer, such techniques could provide alternative surface finishes to change the reflective properties of the final image panel.

The second layer 2 is a gel coat. This layer is not essential to the invention. The gel coat 2 can be textured as an alternative way to give a non glossy characteristic to the display, i.e. it provides a matt surface. A matt surface is usually preferred for panels for display in European exhibitions. However it is known that it is sometimes preferred to have glossy displays. In these instances the panel would be manufactured without the gel coat 2 or with a smooth gel coat.

The third layer 3 in the embodiment illustrated is an emulsion layer. The third layer could alternatively be an ink receiver layer. At least one layer is provided. The third layer 3 carries the image to be displayed.

The fourth layer 4 is a waterproof overcoat. This layer is not essential to the invention. However a waterproof overcoat is desirable since the resulting panel would be more robust. It is possible for the waterproof overcoat to be coated, in a permeable state, as part of the emulsion pack. It is then converted into a waterproof state during processing or by a heat/pressure fusing process. However it is also possible for the waterproof overcoat to be applied after image formation..

The panel according to the invention is manufactured using known coating techniques. The layer 1 of opaque material is directly coated with the image carrying layer 3. If a matt surface is required for the display panel the layer 1 is either textured or pre-coated with a gel coat prior to being coated with the image carrying layer. The gel coat, or alternative coating, is then textured as required. Finally, a waterproof layer 4 is coated onto the front of the image carrying layer 3. This waterproof layer 4 is permeable during processing but becomes waterproof on drying. Examples of waterproof coats can be found in U.S. Pat. Nos. 6,221,546, 6,165,653 and 6,479,222

The display panel produced according to this coating method is ready to be used in exhibitions without any further processes being required. The panel has sufficient stiffness and flexibility to be used in the “pop up” frameworks described above.

Known coating techniques can be used to produce the display panel according to the present invention. No new equipment is needed. Using a coating technique to produce the display panel negates the requirement for the panel to be laminated. The display panel according to the invention has sufficient stiffness and opacity for the panel to be used without the lamination required by prior art techniques.

The invention has been described in detail with reference to preferred embodiments thereof. It will be understood by those skilled in the art that variations and modifications can be effected within the scope of the invention.

What is claimed is:

1. A method of forming a display panel comprising the step of coating an opaque support layer with at least one image carrying layer, the support layer providing stiffness to the panel.

2. A method as claimed in claim 1 wherein the at least one image carrying layer is an emulsion layer.

3. A method as claimed in claim 1 wherein the at least one image carrying layer is an ink receiving layer.

4. A method as claimed in claim 1 wherein the support layer is formed of a plastics material.

5. A method as claimed in claim 1 wherein the support layer is formed of aluminum.

6. A method as claimed in claim 1 wherein the opaque support layer is pre-coated with a gel coat.

7. A method as claimed in claim 1 including a further step of coating the at least one image carrying layer with a waterproof overcoat.

8. A display panel comprising an opaque support layer coated with at least one image carrying layer, the support layer providing stiffness to the panel.

9. A panel as claimed in claim 8 wherein the at least one image carrying layer is an emulsion layer.

10. A panel as claimed in claim 8 wherein the at least one image carrying layer is an ink receiving layer.

11. A panel as claimed in claim 8 wherein the support layer is a plastics material.

12. A panel as claimed in claim 8 wherein the support layer is aluminum.

13. A panel as claimed in claim 8 wherein a gel coat is provided between the support layer and the at least one image carrying layer.

14. A panel as claimed in claim 8 including a waterproof overcoat coated onto the at least one image carrying layer.
